(19) United States
(12) Patent Application Publication
(10) Pub. No.: US 2020/0104024 A1
(43) Pub. Date: Apr. 2, 2020

(54) COMMUNICATION TERMINAL, INFORMATION SHARING SYSTEM, DISPLAY CONTROL METHOD, AND NON-TRANSITORY COMPUTER-READABLE MEDIUM

(71) Applicants: Hiroshi BABA, Kanagawa (JP); Eiichiro Yoshida, Kanagawa (JP); Naohiko Kubo, Kanagawa (JP); Yuuta Hashimoto, Tokyo (JP)

(72) Inventors: Hiroshi BABA, Kanagawa (JP); Eiichiro Yoshida, Kanagawa (JP); Naohiko Kubo, Kanagawa (JP); Yuuta Hashimoto, Tokyo (JP)

(21) Appl. No.: 16/582,277

(22) Filed: Sep. 25, 2019

(30) Foreign Application Priority Data
Sep. 28, 2018 (JP) 2018-185516
Sep. 11, 2019 (JP) 2019-165525

(51) Int. Cl. G06F 3/0486; H04L 29/08; G06F 3/14

(52) U.S. Cl. CPC G06F 3/0486; H04L 67/1097; H04L 65/403; H04L 67/02; G06F 3/1454

(57) ABSTRACT

A communication terminal communicable with a content management server includes circuitry to display a first operation display area, a content in the first operation display area based on data of the content transmitted by the content management server, and a second operation display area by a web browser, receive a drag and drop operation for causing the content displayed in the first operation display area to be dragged and dropped to the second operation display area, in response to reception of the drag and drop operation, transmit location specifying information to the content management server, receive the data of the dragged and dropped content to be displayed in the second operation display area, the data of the dragged and dropped content being transmitted by the content management server in response to transmission of the location specifying information, and display the dragged and dropped content in the second operation display area.

### CROSS-REFERENCE TO RELATED APPLICATIONS

This patent application is based on and claims priority pursuant to 35 U.S.C. § 119(a) to Japanese Patent Application Nos. 2018-185516, filed on Sep. 28, 2018, and 2019-165525, filed on Sep. 11, 2019, in the Japan Patent Office, the entire disclosures of which are hereby incorporated by reference herein.

### BACKGROUND

### Technical Field

The present disclosure relates to sharing contents via a communication network.

### Description of the Related Art

In recent years, telework using an information communication technology (TCT) has been adopted, which allows employees to work flexibly without being restricted by where and when they work. To allow persons at different remote places to join a conference or a meeting even when one or more of them work remotely, materials or documents used in the conference or meeting are shared via a communication network or a videoconference is held via the communication network. In this case, a sever sets up a virtual room. Users who have joined this virtual room by using their personal terminals or the like share materials or documents, thereby a virtual meeting close to a real meeting room can be held. Such information sharing system allows an individual user to share a content of his or her own document in the virtual room or to import a content of a document being shared in the virtual room as his or her own document. For example, a user causes a personal terminal such as a personal computer (PC) to display a shared window (graphical user interface (GUI) of the PC) by a web browser, and causes the shared window to display a shared content acquired from a server, thereby conducting a remote meeting. Further, the user activates a personal window, different from the shared window, at the same personal terminal by using word processor software, spreadsheet software or presentation software, thereby conducting a remote meeting while viewing personal documents.

### SUMMARY

According to an embodiment, a communication terminal is communicable with a content management server. The communication terminal includes circuitry to display a first operation display area, a content in the first operation display area based on data of the content transmitted by the content management server, and a second operation display area by a web browser, receive a drag and drop operation for causing the content displayed in the first operation display area to be dragged and dropped to the second operation display area, in response to reception of the drag and drop operation, transmit location specifying information that specifies a location of data of the dragged and dropped content, to the content management server, receive the data of the dragged and dropped content to be displayed in the second operation display area, the data of the dragged and dropped content being transmitted by the content management server in response to transmission of the location specifying information, and display the dragged and dropped content in the second operation display area.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic diagram illustrating an overview of an information sharing system, according to an embodiment of the present disclosure;

FIG. 2 is a block diagram illustrating an example of a hardware configuration of a personal terminal, a shared terminal, and a content management server of the information sharing system, according to an embodiment of the present disclosure;

FIG. 3 is a block diagram illustrating an example of a functional configuration of the personal terminal, the shared terminal, and the content management server of the information sharing system, according to an embodiment of the present disclosure;

FIG. 4A is a conceptual diagram illustrating an example data structure of a personal content management table, according to an embodiment of the present disclosure;

FIG. 4B is a conceptual diagram illustrating an example data structure of a shared content management table, according to an embodiment of the present disclosure;

FIG. 5 is a conceptual diagram illustrating processes of copying a content from a personal electronic canvas to a shared electronic canvas, according to a first embodiment of the present disclosure;

FIG. 6 is a sequence diagram illustrating an operation of inputting and displaying a content, according to an embodiment of the present disclosure;

FIG. 7 is a sequence diagram illustrating an operation of copying, in a case where a content to be copied is a screen element, according to an embodiment of the present disclosure;

FIG. 8A is a conceptual diagram illustrating an operation display area and a display position of a content on the personal electronic canvas having an infinite space, according to an embodiment of the present disclosure;

FIG. 8B is a conceptual diagram illustrating an operation display area and a display position of a content on the shared electronic canvas having an infinite space, according to an embodiment of the present disclosure;

FIG. 9 is a flowchart illustrating an operation of identifying a request content, according to an embodiment of the present disclosure;

FIG. 10 is a sequence diagram illustrating an operation of copying, in a case where a content to be copied is a screen element, according to an embodiment of the present disclosure;

FIG. 11 is a conceptual diagram illustrating processes of copying a content from the shared electronic screen to the personal electronic canvas, according to a second embodiment of the present disclosure;

FIG. 12 is a sequence diagram illustrating an operation of copying, in a case where a content to be copied is an entire screen, according to an embodiment of the present disclosure; and

FIG. 13 is a sequence diagram illustrating an operation of copying, in a case where a content to be copied is an entire screen, according to an embodiment of the present disclosure.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

### First Embodiment

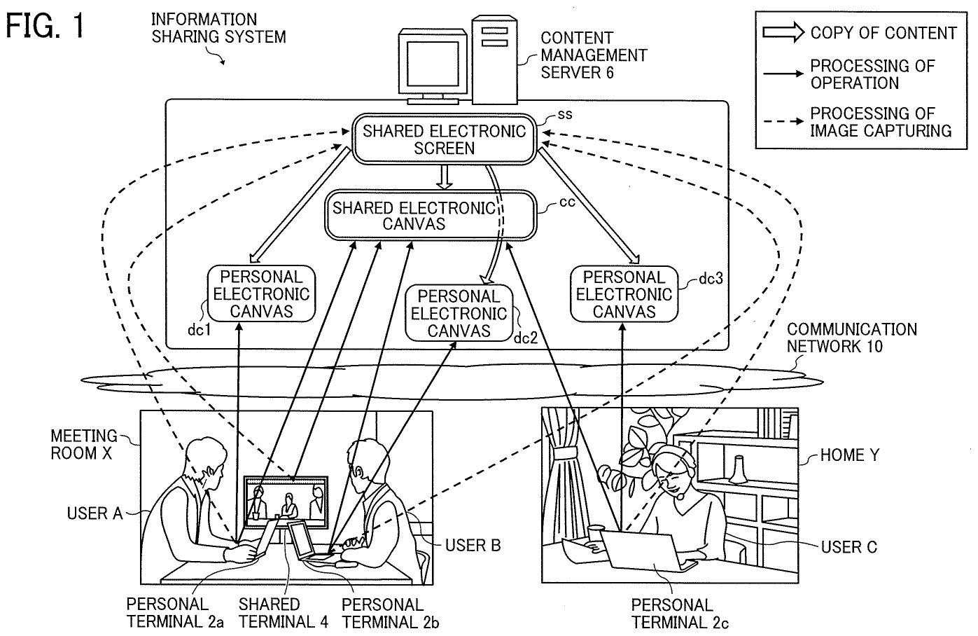

A description is now given of a first embodiment of the present disclosure, with reference to FIG. 1 to FIG. 10.

### Overview of Information Sharing System:

First, with reference to FIG. 1, an overview of an information sharing system according to the present embodiment is described. FIG. 1 is a schematic diagram illustrating an overview of the information sharing system according to the present embodiment. FIG. 1 illustrates a case in which a user A and a user B who are in a meeting room X of the company and a user C who is at a home Y are conducting a remote meeting by using the information sharing system. The user A uses a personal terminal 2a in the meeting room X, and the user

B uses a personal terminal 2b in the meeting room X. Further, a shared terminal 4 that can be shared by multiple users is provided in the meeting room X. On the other hand, the user C uses a personal terminal 2c at the home Y. In the following description, the personal terminal 2a, the personal terminal 2b, and the personal terminal 2c are collectively referred to as simply a “personal terminal 2” or “personal terminals 2”, unless they need to be distinguished from each other.

The personal terminal 2 is a computer that a user can use individually or exclusively and whose screen is viewed by the user individually. The personal terminal 2 is not limited to being privately-owned. The personal terminal 2 may be public, private, non-profit, rental or any other type of ownership terminal in which a user may individually or exclusively use the terminal and whose screen is viewed by the user individually. The shared terminal 4 is a computer that multiple users can use together or share and whose screen is viewed by the multiple users. Examples of the personal terminal 2 and the shared terminal 4 include a tablet terminal, a smartphone, a PC, a personal digital assistant (PDA), a smartwatch, an electronic whiteboard, a digital television, a game apparatus, and a multifunction peripheral (MFP) having a copier function, and a car navigation system. Each of the personal terminals 2 and the shared terminal 4 is an example of a communication terminal (or an information processing terminal).

Each of the personal terminals 2 and the shared terminal 4 can communicate with the content management server 6 via a communication network 10 such as the Internet. The communication network 10 is, for example, one or more local area networks (LANs) inside the firewall. In another example, the network N includes the Internet that is outside the firewall in addition to the LAN. In another example, the communication network 10 further includes a virtual private network (VPN) and/or a wide-area Ethernet (registered trademark). The communication network 10 is any one of a wired network, a wireless network, and a combination of the wired network and the wireless network. In a case where the shared terminal 4, the personal terminal 2 or the content management server 6 connects to the communication network 10 through a mobile phone network such as 3G, Long Term Evolution (LTE), 4G, the LAN can be omitted. The content management server 6 is a computer, or a plurality of computers, having a function as a web server (or HTTP server) that stores and manages data of contents to be transmitted to the personal terminal 2 and the shared terminal 4. The content management server 6 includes a storage unit 6000 described below. The storage unit 6000 includes a storage location (or a storage area) for implementing a personal electronic canvas that can be accessed only from each personal terminal 2. More specifically, only the personal terminal 2a, the personal terminal 2b and the personal terminal 2c can access a personal electronic canvas dc1, a personal electronic canvas dc2 and a personal electronic canvas dc3, respectively. In the following description, the personal electronic canvas dc1, the personal electronic canvas dc2 and the personal electronic canvas dc3 are collectively referred to as simply a “personal electronic canvas dc”, unless they need to be distinguished from each other.

The content management server 6 can support cloud computing. The “cloud computing” refers to internet-based computing where resources on a network are used or accessed without identifying specific hardware resources. Further, the storage unit 6000 of the content management server 6 includes a storage location (or a storage area) for implementing a shared electronic canvas cc that can be accessed from each of the personal terminals 2. Furthermore, the storage unit 6000 of the content management server 6 includes a storage location (or a storage area) for implementing a shared electronic screen ss that can be accessed from each of the personal terminals 2.

In this disclosure, the “electronic canvas” is not a plain-woven thick cloth but a virtual space generated in the storage location (or the storage area) in the storage unit 6000 of the content management server 6. For example, the electronic canvas can be accessed by using a web application for an electronic canvas, the web application having a function of allowing a user to view and edit a content with the canvas element and JavaScript (registered trademark). The “web application” refers to software used on a web browser. The web application is implemented by a program written in a script language such as JavaScript (registered trademark) that operates on a web browser and a program on a web server side, which operates in cooperation with each other. Further, the web application refers to a mechanism that implements such software. The personal electronic canvas and the shared electronic canvas have infinite areas within the range of the storage area in the storage unit 6000.

In addition, the “electronic screen” is not a white screen for projecting a movie or a slide image for viewing but a virtual space generated in a storage location (or storage area) in the storage unit 6000 of the content management server 6. Different from the electronic canvas, editing of contents cannot be performed on the electronic screen. The electronic screen has a function of holding a previous content until acquiring the next content. The electronic screen can be accessed by using a web application for an electronic screen, the web application having a function of allowing a user to view a content with a part of web real-time communication (webRTC).

The “personal electronic canvas” refers to an electronic space dedicated to each user participating in a remote meeting. The personal terminal 2 of each user can access only the personal electronic canvas dedicated to the corresponding user, which allows the corresponding user to view and/or edit (input, delete, copy, etc.) contents such as characters and images on the accessed personal electronic canvas. The “shared electronic canvas” refers to an electronic space that users participating in the remote meeting use together or share. Any of the personal terminals 2 of the users can access the shared electronic canvas, which allows the users to view and/or edit (input, delete, copy, etc.) contents such as characters and images. The “shared electronic screen” refers to an electronic space shared by users participating in the remote meeting. Any of the personal terminals 2 of the users can access the shared electronic screen, which allows the users to view a shared screen held by the shared electronic screen. However, different from the personal electronic canvas and the shared electronic canvas, the shared electronic screen cannot edit contents. For example, in a case where data of a content is transmitted from the personal terminal 2a to the shared electronic screen ss and thereafter data of a content is transmitted from the personal terminal 2b to the shared electronic screen ss, data of a content held by the shared electronic screen ss is the data received latest.

Each personal terminal 2 causes the above-described web application operating on the web browser installed in the personal terminal 2 to display a content of the personal electronic canvas dc, the shared electronic canvas cc, and the shared electronic screen ss.

Although FIG. 1 illustrates a case where the remote meeting is held between two sites (e.g., the meeting room X and the home Y), this is just an example. In another example, a meeting is held in one site. In still another example, a remote meeting is performed in three or more sites.

### Hardware Configuration:

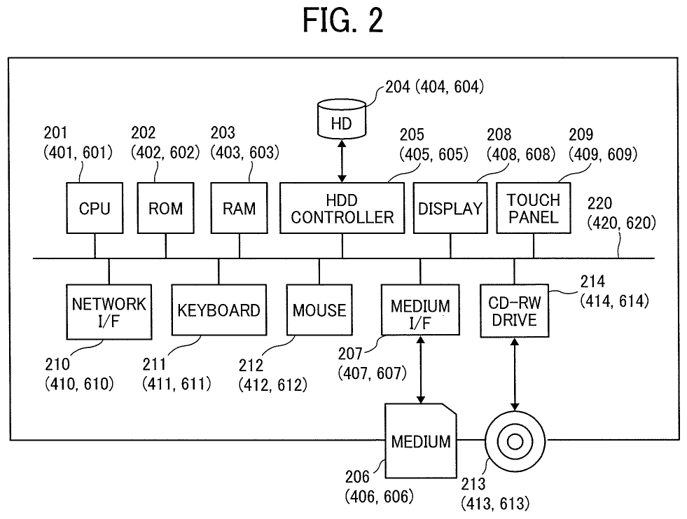

With reference to FIG. 2, a description is given of an example of a hardware configuration of the personal terminal 2, the shared terminal 4, and the content management server 6 of the information sharing system. FIG. 2 is a block diagram illustrating an example of a hardware configuration of the personal terminal 2, the shared terminal 4, and the content management server 6 of the information sharing system.

### Hardware Configuration of Personal Terminal:

As illustrated in FIG. 2, the personal terminal 2 includes a central processing unit (CPU) 201, a read only memory (ROM) 202, a random access memory (RAM) 203, a hard disc (HD) 204, a hard disc drive (HDD) controller 205, a storage medium 206, a medium interface (I/F) 207, a display 208, a touch panel 209, a network I/F 210, a keyboard 211, a mouse 212, a compact disc rewritable (CD-RW) drive 214, and a bus line 220.

The CPU 201 controls entire operation of the personal terminal 2. The ROM 202 stores a program to boot the CPU 201. The RAM 203 is used as a work area for the CPU 201. The HD 204 stores various data such as a control program. The HDD controller 205 controls reading and writing of various data from and to the HD 204 under control of the CPU 201. The medium I/F 207 controls reading and writing (storing) of data from and to the storage medium 206 such as a flash memory. The display 208 displays various information such as a cursor, menu, window, characters, or image. The touch panel 209 is one example of an input device (input means) that allows a user to operate the personal terminal 2 by touching a screen of the display 208. The network I/F 210 is an interface that controls communication of data through the communication network 10. The keyboard 211 is one example of an input device (input means) provided with a plurality of keys for allowing a user to input characters, numerals, or various instructions. The mouse 212 is one example of an input device (input means) that allows a user to select a specific instruction or execution, select a target for processing, or move a cursor being displayed. The CD-RW drive 214 reads and writes various data to and from to a CD-RW 213, which is one example of a removable storage medium.

### Hardware Configuration of Content Management Server:

The shared terminal 4 includes a CPU 401, a ROM 402, a RANI 403, an HD 404, an HDD controller 405, a storage medium 406, a medium I/F 407, a display 408, a touch panel 409, a network I/F 410, a keyboard 411, a mouse 412, a CD-RW drive 414, and a bus line 420. Since these hardware elements are the same or substantially the same as the CPU 201, ROM 202, RAM 203, the HD 204, the HDD controller 205, the storage medium 206, the medium I/F 207, the display 208, the touch panel 209, the network I/F 210, the keyboard 211, the mouse 212, the CD-RW drive 214, and the bus line 220, redundant descriptions thereof are omitted below.

The content management server 6 includes a CPU 601, a ROM 602, a RAM 603, an HD 604, an HDD controller 605, a storage medium 606, a medium I/F 607, a display 608, a touch panel 609, a network I/F 610, a keyboard 611, a mouse 612, a CD-RW drive 614, and a bus line 620. Since these hardware elements are the same or substantially the same as the CPU 201, ROM 202, RAM 203, the HD 204, the HDD controller 205, the storage medium 206, the medium I/F 207, the display 208, the touch panel 209, the network I/F 210, the keyboard 211, the mouse 212, the CD-RW drive 214, and the bus line 220, redundant descriptions thereof are omitted below. The content management server 6 may not include the touch panel 609.

Instead of the CD-RW drive, a digital versatile disc recordable (DVD-R) drive or the like can be used. Each of the personal terminal 2, the shared terminal 4 and the content management server 6 can be configured by a single computer or a plurality of computers to which divided portions (functions, means, or storages) are arbitrarily allocated.

### Functional Configuration:

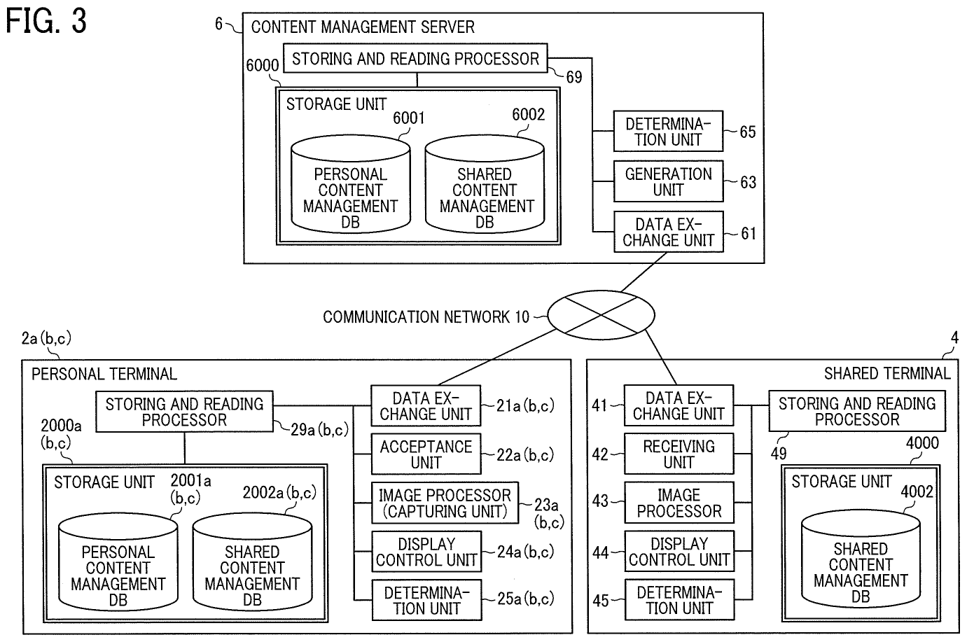

With reference to FIG. 3, a description is given of an example of a functional configuration of each of the personal terminal 2, the shared terminal 4, and the content management server 6 of the information sharing system. FIG. 3 is a block diagram illustrating an example of a functional configuration of the personal terminal 2, the shared terminal 4, and the content management server 6 of the information sharing system.

### Functional Configuration of Personal Terminal:

First, a description is given of an example of a functional configuration of the personal terminal 2a. As illustrated in FIG. 3, the personal terminal 2a includes a data exchange unit 21a, a receiving unit 22a, an image processor 23a, a display control unit 24a, a determination unit 25a, and a storing and reading processor 29a. These units are functions that are implemented by or that are caused to function by operating any of the hardware elements illustrated in FIG. 2 in cooperation with the instructions of the CPU 201 according to the control program expanded from the HD 204 to the RAM 203. The personal terminal 2a further includes a storage unit 2000a, which is implemented by the RAM 203 and the HD 204 illustrated in FIG. 2.

### Personal Content Management DB:

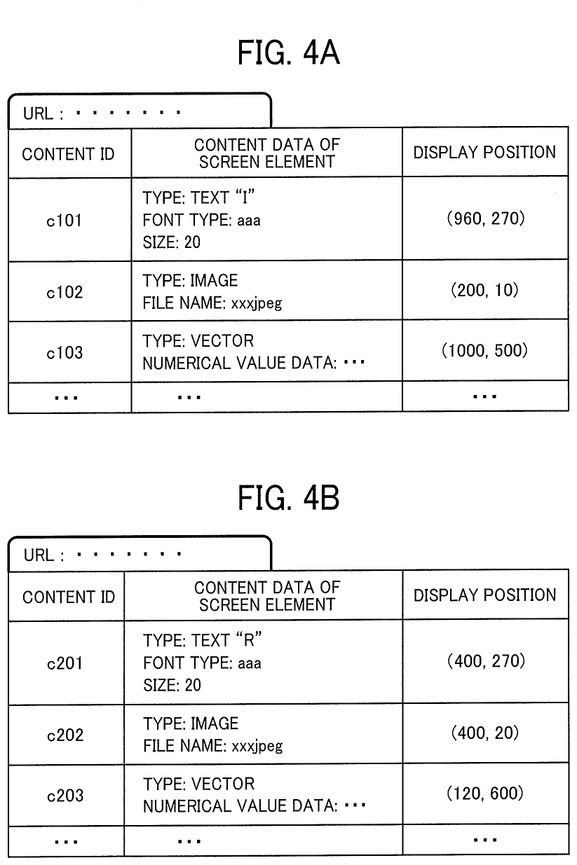

FIG. 4A is a conceptual diagram illustrating an example data structure of a personal content management table. The storage unit 2000a of the personal terminal 2a stores a personal content management database (DB) 2001a implemented by the personal content management table as illustrated in FIG. 4A. Data stored in the personal content management table is the same as data stored for each of the personal terminals 2 in a personal content management DB 6001 described below of the content management server 6. For example, the personal terminal 2a acquires data for the personal terminal 2a from among the data for the personal terminals 2 stored in the content management server 6 and stores the acquired data in the personal content management DB 2001a.

Further, the personal content management table stores, for each uniform resource locator (URL) specifying an access location (position) of the personal electronic canvas, a content ID, data of a content, and content display position information in association with each other. The content ID is an example of content identification information for identifying each content. The data of a content is data such as text data, image data such as screen capture image data, and vector data obtained by drawing. The display position information indicates a display position of the content on the personal electronic canvas. This display position indicates a position where the corresponding content is displayed on the personal electronic canvas as an infinite canvas.

The URL is an example of location specifying information. Examples of the location specifying information further include a uniform resource identifier, which uses a location or a name to identify a particular resource.

### Shared Content Management DB:

FIG. 4B is a conceptual diagram illustrating an example data structure of a shared content management table. The storage unit 2000a of the personal terminal 2a stores a shared content management DB 2002a implemented by the shared content management table as illustrated in FIG. 4B. Data stored in the shared content management table is the same as data stored in a shared content management DB 6002 described below of the content management server 6. For example, the personal terminal 2a acquires the data stored in the shared content management DB 6002 of the content management server 6 and stores the acquired data in the shared content management DB 2002a.

Further, the shared content management table stores, for each URL specifying an access location (position) of the shared electronic canvas, a content ID, data of a content, and content display position information in association with each other. The same description given above with reference to FIG. 4A of the content ID, the content data, and the display position information of the personal content management table applies to the content ID, the content data, and the display position information of the shared content management table. Accordingly, redundant descriptions thereof are omitted below.

### Each Functional Unit of Personal Terminal:

Next, a detailed description is given of each functional unit of the personal terminal 2a.

The data exchange unit 21a is mainly implemented by instructions of the CPU 201 and the network I/F 210 illustrated in FIG. 2. The data exchange unit 21a transmits and receives various data (or information) to and from other terminals, apparatuses, servers, etc. via the communication network 10. For example, the data exchange unit 21a receives, from the content management server 6, content data described in a hypertext markup language (HTML), Cascading Style Sheet (CSS), and JavaScript (registered trademark). In addition, the data exchange unit 21a transmits operation information input by the user to the content management server 6.

The receiving unit 22a, which is mainly implemented by instructions of the CPU 201 illustrated in FIG. 2, receives various selections or instructions input by the user using the keyboard 211 and the mouse 212.

The image processor 23a, which is mainly implemented by instructions of the CPU 201 illustrated in FIG. 2, performs processing such as generating vector data (or stroke data) according to drawing by the user, for example.

The display control unit 24a, which is mainly implemented by instructions of the CPU 201 illustrated in FIG. 2, controls the display 208 to display contents of various images and screens.

The determination unit 25a, which is mainly implemented by instructions of the CPU 201 illustrated in FIG. 2, performs various types of determination.

The storing and reading processor 29a is implemented by the HDD controller 205, the medium I/F 207 and the CD-RW drive 214, which operate in accordance with instructions of the CPU 201 illustrated in FIG. 2. The storing and reading processor 29a stores various types of data in the storage unit 2000a, the storage medium 206 and the CD-RW 213. Further, the storing and reading processor 29a reads out various types of data from the storage unit 2000a, the storage medium 206 and the CD-RW 213.

The personal terminal 2b includes a data exchange unit 21b, a receiving unit 22b, an image processor 23b, a display control unit 24b, a determination unit 25b, and a storing and reading processor 29b. The personal terminal 2c includes a data exchange unit 21c, an acceptance unit 22c, an image processor 23c, a display control unit 24c, a determination unit 25c, and a storing and reading processor 29c. These units are functions that are implemented by or that are caused to function by operating any of the hardware elements illustrated in FIG. 2 in cooperation with the instructions of the CPU 201 according to the control program expanded from the HD 204 to the RAM 203. The personal terminal 2b and the personal terminal 2c further include a storage unit 2000b and a storage unit 2000c, respectively, each of which is implemented by the RAM 203 and the HD 204 illustrated in FIG. 2. The functions of the data exchange units 21b and 21c, the receiving units 22b and 22c, the image processors 23b and 23c, the display control units 24b and 24c, the determination units 25b and 25c, the storing and reading processors 29b and 29c, and the storage units 2000b and 2000c are the same or substantially the same as those of the data exchange unit 21a, the receiving unit 22a, the image processor 23a, the display control unit 24a, the determination unit 25a, the storing and reading processor 29a, and the storage unit 2000a of the personal terminal 2a respectively, and therefore redundant description thereof are omitted below.

### Personal Content Management DB:

The storage unit 2000b of the personal terminal 2b stores a personal content management DB 2001b and a shared content management DB 2002b. The storage unit 2000c of the personal terminal 2c stores a personal content management DB 2001c and a shared content management DB 2002c. The personal content management DBs 2001b and 2001c and the shared content management DBs 2002b and 2002c have the same or substantially the same data structures as the personal content management DB 2001a and the shared content management DB 2002a, respectively, and therefore redundant descriptions thereof are omitted below.

### Functional Configuration of Shared Terminal:

A description is now given of an example of a functional configuration of the shared terminal 4. As illustrated in FIG. 3, the shared terminal 4 includes a data exchange unit 41, a receiving unit 42, an image processor 43, a display control unit 44, a determination unit 45, and a storing and reading processor 49. These units are functions that are implemented by or that are caused to function by operating any of the hardware elements illustrated in FIG. 2 in cooperation with the instructions of the CPU 401 according to the control program expanded from the HD 404 to the RAM 403. The shared terminal 4 further includes a storage unit 4000, which is implemented by the RAM 403 and the HD 404 illustrated in FIG. 2. The functions of the data exchange unit 41, the receiving unit 42, the image processor 43, the display control unit 44, the determination unit 45, the storing and reading processor 49, and the storage unit 4000 of the shared terminal 4 are the same of the substantially the same as those of the data exchange unit 21a, the receiving unit 22a, the image processor 23a, the display control unit 24a, the determination unit 25a, the storing and reading processor 29a, and the storage unit 2000a of the personal terminal 2a respectively, and therefore redundant descriptions thereof are omitted below.

Further, the storage unit 4000 of the shared terminal 4 stores a shared content management DB 4002. Since the shared content management DB 4002 has the same or substantially the same data structure as the shared content management DB 2002a of the personal terminal 2a, a redundant description thereof is omitted below.

### Functional Configuration of Content Management Server:

A description is now given of an example of a functional configuration of the content management server 6. As illustrated in FIG. 3, the content management server 6 includes a data exchange unit 61, a generation unit 63, a determination unit 65, and a storing and reading processor 69. These units are functions that are implemented by or that are caused to function by operating any of the hardware elements illustrated in FIG. 2 in cooperation with the instructions of the CPU 601 according to the control program expanded from the HD 604 to the RANI 603. The content management server 6 further includes a storage unit 6000, which is implemented by the RAM 603 and the HD 604 illustrated in FIG. 2.

### Each Functional Unit of Content Management Server:

Next, a detailed description is given of each functional unit of the content management server 6.

The data exchange unit 61 is mainly implemented by instructions of the CPU 601 and the network I/F 610 illustrated in FIG. 2. The data exchange unit 61 transmits and receives various data (or information) to and from other terminals, apparatuses, servers, etc. via the communication network 10.

The generation unit 63, which is mainly implemented by instructions of the CPU 601 illustrated in FIG. 2, generates a unique content ID or the like.

The determination unit 65, which is mainly implemented by instructions of the CPU 601 illustrated in FIG. 2, determines whether the content ID has been received by the data exchange unit 61.

I/F 607 and the CD-RW drive 614, which operate in accordance with instructions of the CPU 601 illustrated in FIG. 2. The storing and reading processor 69 stores various types of data in the storage unit 6000, the storage medium 606 and the CD-RW 613. Further, the storing and reading processor 69 reads out various types of data from the storage unit 6000, the storage medium 606 and the CD-RW 613.

The storage unit 6000 of the content management server 6 stores the personal content management DB 6001 and the shared content management DB 6002. The personal content management DB 6001 and the shared content management DB 6002 have the same or substantially the same data structures as the personal content management DB 2001a and the shared content management DB 2002a, respectively, and therefore redundant descriptions thereof are omitted below.

However, the personal content management DB 6001 stores all data of the personal content management DBs 2001a, 2001b, and 2001c. Further, the shared content management DB 6002 has all data of the shared content management DBs 2002a, 2002b, 2002c and the shared content management DB 4002.

The above described programs may be stored in a storage medium such as a CD-R or a DVD-R for domestic or overseas distribution.

### Processes or Operation:

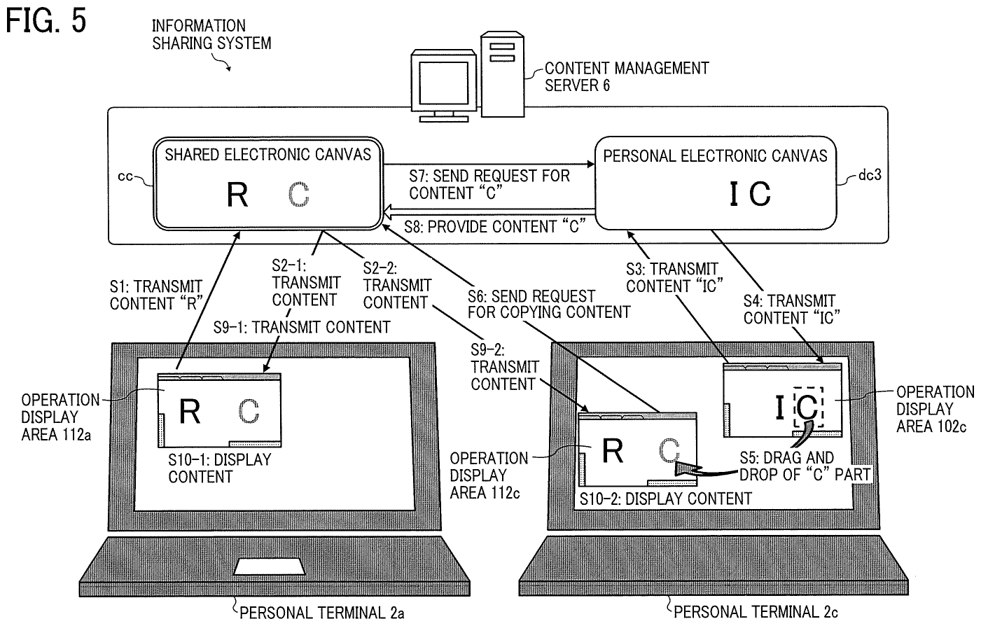

A description is given now of an operation or processes according to the present embodiment, with reference to FIG. 5 to FIG. 10.

### Overview of Operation or Processes:

First, a description is given of an overview of an operation or processes according to the first embodiment, with reference to FIG. 5. FIG. 5 is a conceptual diagram illustrating processes of copying a content from the personal electronic canvas to the shared electronic canvas, according to the first embodiment.

A description given hereinafter is of a case where the user A inputs text data “R” to the shared electronic canvas cc from the personal terminal 2a and shares the information with the personal terminals 2b and 2c, and thereafter the user C copies, to the shared electronic canvas cc, a content “C” as a screen element from among a content “IC” as a screen element that the user C has input to his or her own personal electronic canvas dc3 to share the information with all the users participating in the remote meeting.

Note that in the present embodiment, the content “C” as the screen element is an example of a particular content. Further, a storage location (storage area) in the storage unit 6000, which is an access destination (URL) to the personal electronic canvas dc3, is an example of a first storage area in the storage unit 6000. A storage location (storage area) in the storage unit 6000, which is an access destination (URL) to the shared electronic canvas cc, is an example of a second storage area in the storage unit 6000.

An operation display area described below is an area on a screen for displaying information to be presented to a user with graphical user interfaces (GUIs) or for accepting an operation from the user. The operation display area is a display mode of a web browser or application software. For example, Microsoft Windows (registered trademark) or the like corresponds to the operation display area. An operation display area 102c and an operation display area 112c each represents a given area in the shared electronic canvas cc having an infinite space. An operation display area 102c represents a given area in the personal electronic canvas dc3 having an infinite space.

First, at the personal terminal 2a, a content “R” is input on the operation display area 112a for displaying a content of the shared electronic canvas cc. The personal terminal 2a transmits data of the content “R” to the shared electronic canvas cc of the content management server 6 (S1). In response, the content management server 6 transmits the data of the content “R” to all the personal terminals 2 (in FIG. 5, personal terminal 2a and the personal terminal 2c) participating in the remote meeting (S2-1 and S2-2). At the personal terminal 2a, the content “R” is displayed in the operation display area 112a by the web browser. At the personal terminal 2c, the content “R” is displayed in the operation display area 112c by the web browser.

Further, at the personal terminal 2c, a content “IC” is input on the operation display area 102c for displaying a content of the personal electronic canvas dc3. The personal terminal 2c transmits data of the content “IC” to the personal electronic canvas dc3 of the content management server 6 (S3). In response, the content management server 6 transmits the data of the content “IC” to the personal terminal 2c (S4). At the personal terminal 2c, the content “IC” is displayed in the operation display area 102c by the web browser.

In the state where the processes from S1 to S4 has been performed, the user C drags and drops a content (“C” in this embodiment) as a screen element on the operation display area 102c to a desired position on the operation display area 112c to copy the content, such that information that the user C himself or herself has input be shared with the other users participating in the remote meeting (S5). Note that in the present embodiment, the operation display area 102c is an example of a first operation display area, and the operation display area 112c is an example of a second operation display area.

Next, the personal terminal 2c sends a copy request requesting copying of the content “C” to the content management server 6 by the web browser that displays the operation display area 112c (S6). This copy request includes a content ID of the content “C” and the URL of the personal electronic canvas dc3, which is a copy source. That is, the copy source can be specified by the drag and drop operation. Note that the appearance of the content at the copy source can be changed to semi-transparent until the content is displayed at a copy destination after the copy source is specified by the drag and drop operation.

Next, at the content management server 6, the shared electronic canvas cc sends a request for data of the content to the URL of the personal electronic canvas dc3 (S7). A target of this request is identified by the content ID of the content “C”. At the content management server 6, the personal electronic canvas dc3 provides the data of the content “C” to the shared electronic canvas cc (S8). In response, the content management server 6 transmits data of a content “RC” to all the personal terminals 2 (in FIG. 5, the personal terminals 2a and the personal terminal 2c) participating in the remote meeting (S9-1, S9-2). At the personal terminal 2a, the content “RC” is displayed in the operation display area 112a by the web browser (S10-1). At the personal terminal 2c, the content “RC” is displayed in the operation display area 112c by the web browser (S10-2).

As described heretofore with reference to FIG. 5, in a case where a content is displayed by the web browser of the personal terminal 2c, the user C of the personal terminal 2c performs an operation of copying the content “C” as a screen element from the operation display area 102c to a desired position in the operation display area 112c by drag and drop at his or her own personal terminal 2c, thereby causing the content management server 6 to copy data of the content “C” as the screen element from the personal electronic canvas dc3 to the shared electronic canvas cc.

In the present embodiment, data is not copied in the personal terminal 2c to copy a content of the operation display area 102c to the operation display area 112c. It is the content management server 6 that copies the data, and the personal terminal 2c displays the copied content by the web browser.

In the present embodiment, a content is dragged and dropped from the personal operation display area 102c displayed on the personal terminal 2c to the shared operation display area 112c. However, the present embodiment is not limited to this, and for example, a content can be dragged and dropped from a personal operation display area displayed on the personal terminal 2a or the personal terminal 2b to a shared operation display area displayed on the personal terminal 2a or the personal terminal 2b.

### Details of Operation or Processes:

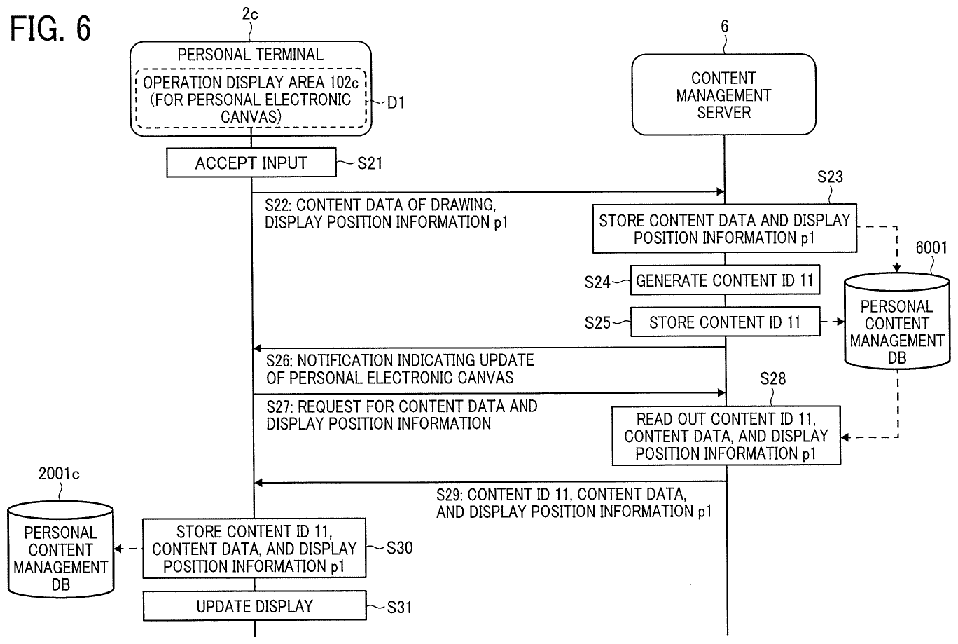

Next, a description is given of details of operation or processes in the first embodiment, with reference to FIGS. 6 to 10. FIG. 6 is a sequence diagram illustrating an operation of inputting and displaying a content. More specifically, a description is given of details of processes of step S5 and subsequent steps on the assumption that the processes of step S1 to step S4 has already been performed.

First, at the personal terminal 2c, when the user C inputs the content “IC” as a screen element by using the keyboard 211 and the mouse 212, the acceptance unit 22c receives the input (S21). Then, the data exchange unit 21c transmits, to the content management server 6, data of the content “IC” as the screen element and display position information p1 indicating a display position of the content in the personal electronic canvas dc3 (S22). The data exchange unit 61 of the content management server 6 receives the data of the content “IC” and the display position information p1.

Next, the storing and reading processor 69 of the content management server 6 stores the data of the content “IC” and the display position information p1 in association with each other in the personal content management table in which an URL of the personal electronic canvas dc3 is managed in the personal content management DB 6001 (S23). Then, the generation unit 63 generates a unique content ID 11 (S24).

Next, the storing and reading processor 69 stores the content ID 11 generated in step S24 in association with the content data and display position information p1 stored in step S23 (S25).

Next, the data exchange unit 61 transmits an update notification, which is a notification indicating an update of the personal electronic canvas, to the personal terminal 2c (S26). In a case where the user C has multiple personal terminals 2 and accesses the same personal electronic canvas (URL) from the multiple personal terminals 2, the content management server 6 sends the update notification to each of the multiple personal terminals 2 of the user C. Thereby, the data exchange unit 21c receives the update notification by the web browser displaying the operation display area 102c of the personal terminal 2c.

Next, the data exchange unit 21c transmits a request for updated content data and display position information to the content management server 6 by the web browser displaying the operation display area 102c of the personal terminal 2c (S27). The data exchange unit 61 of the content management server 6 receives the request.

Next, the storing and reading processor 69 of the content management server 6 reads out the content ID 11 corresponding to the updated content, the data of the content “IC”, and the display position information p1 from the personal content management table for the personal electronic canvas dc3 in the personal content management DB 6001 (S28). Then, the data exchange unit 61 transmits the content ID 11, the data of the content “IC”, and the display position information p1 to the personal terminal 2c (S29). Thereby, the data exchange unit 21c receives the content ID 11, the data of the content “IC”, and the display position information p1 by the web browser of the personal terminal 2c.

Next, the storing and reading processor 29c of the personal terminal 2c stores the content ID 11, the data of the content “IC”, and the display position information p1 received in step S29 in association with each other in the personal content management DB 2001c (S30). Thereby, the display control unit 24c updates the operation display area 102c to display the content “IC”, which is a screen element, by the web browser of the personal terminal 2c (S31).

Thus, the operation of inputting and displaying the content ends.

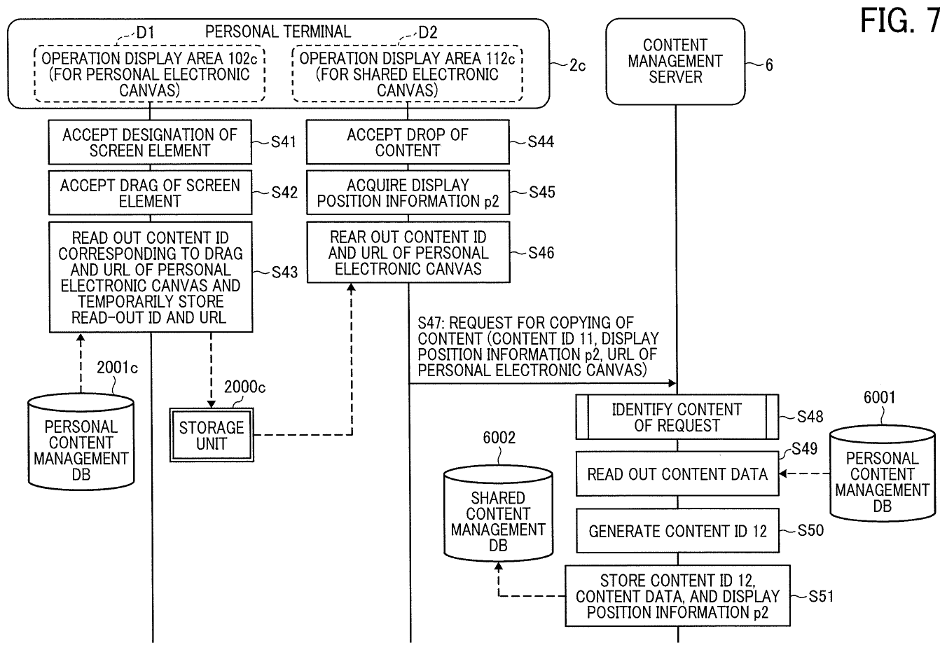

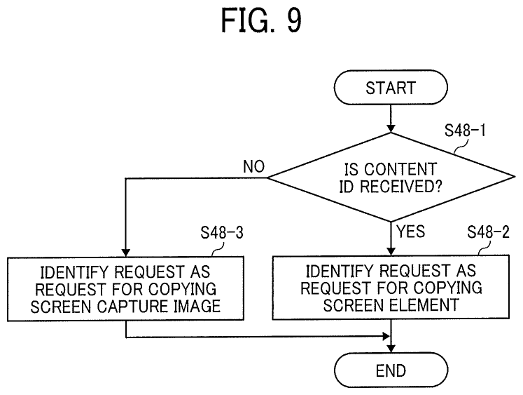

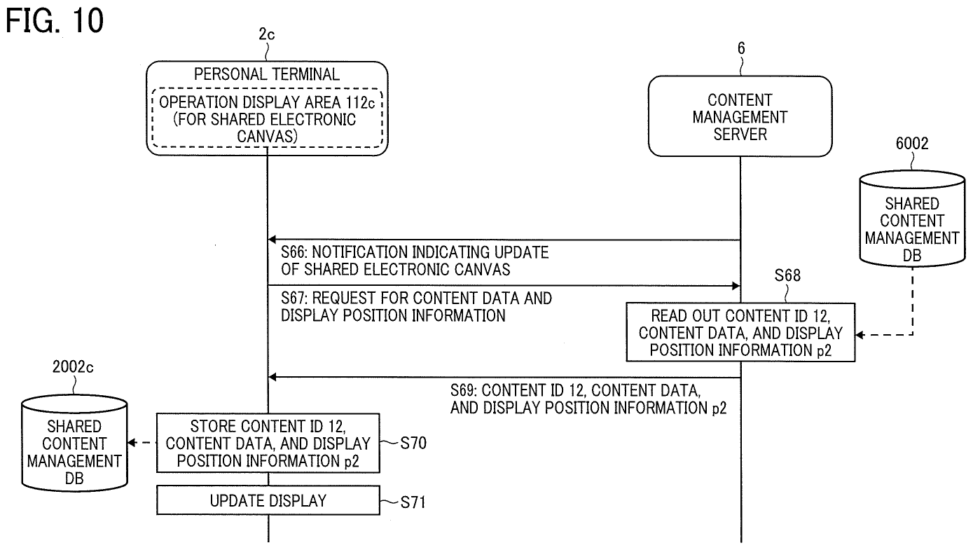

Next, a description is given of an operation of copying in a case where a content to be copied is a screen element, with reference to FIG. 7 to FIG. 10. FIG. 7 and FIG. 10 are sequence diagrams each illustrating an operation of copying, in a case where a content to be copied is a screen element. FIG. 10 illustrates an operation to be performed after the operation illustrated in FIG. 7. FIG. 9 is a flowchart illustrating an operation of identifying a request content.

First, when the user C designates the content “C” from among the content “IC” with the mouse 212 of the personal terminal 2c, the acceptance unit 22c accepts the designation of the content “C” (S41). When the user C drags with the mouse 212, the acceptance unit 22c accepts the drag of the content “C” (S42). Then, the storing and reading processor 29c reads out the content ID 11 corresponding to the drag and the URL of the personal canvas dc3 from the personal content management DB 2001c, and temporarily stores the content ID 11 and the URL that are read out in a clipboard of the storage unit 2000c (S43).

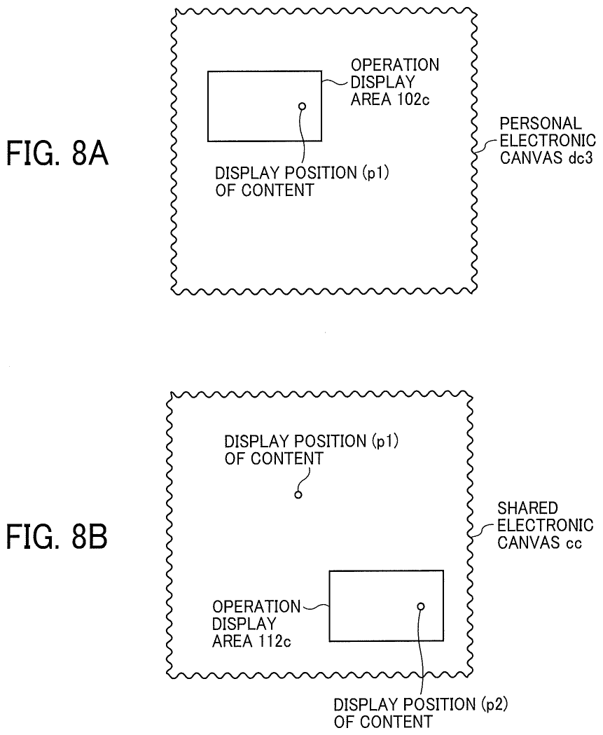

Next, when the user C drops the content “C” at a desired display position in the operation display area 112c with the mouse 212, the acceptance unit 22c accepts the drop (S44). The image processor 23c acquires display position information p2 indicating the drop position in the shared electronic canvas cc by the web browser (a web application of the web browser) operating at the personal terminal 2c (S45). As described, the personal terminal 2c acquires the display position information p2 indicating a position in the operation display area 112c in addition to the display position information p1, described above with reference to FIG. 6, indicating a position in the operation display area 102c. A description is now given of the reason for acquiring the display position information p2, with reference to FIG. 8A and FIG. 8B.

FIG. 8A is a conceptual diagram illustrating the operation display area 102c and the display position of the content on the personal electronic canvas dc3 having an infinite space. FIG. 8B is a conceptual diagram illustrating the operation display area 112c and the display position of the content on the shared electronic canvas cc having an infinite space.

As illustrated in FIG. 8A, the personal electronic canvas dc3 is configured by an infinite area, and a given area in this infinite area is displayed as the operation display area 102c. On the other hand, as illustrated in FIG. 8B, the shared electronic canvas cc is also configured by an infinite area, and a given area in this infinite area is displayed as the operation display area 112c. In FIG. 8A and FIG. 8B, different areas in the infinite electronic canvas are displayed by the operation display area 102c and the operation display area 112c.

As illustrated in FIG. 8A, the content display position (p1) is on the right side of the personal operation display area 102c. In this state, if the content on the personal electronic canvas dc3 is copied to the same position on the shared electronic canvas cc, as illustrated in FIG. 8B, a problem arises the content is not displayed within the shared operation display area 112c. To address this issue, the personal terminal 2c acquires the position (p2) of the content with respect to the operation display area 112c instead of with respect to the shared electronic canvas cc, based on the position (p1) of the content with respect to the operation display area 102c instead of with respect to the personal electronic canvas dc3. Thereby, the content is displayed at the same position when viewed by the user.

Next, referring again to FIG. 7, the storing and reading processor 29c reads out the content ID 11 and the URL of the personal electronic canvas dc3 stored in the storage unit 2000c (S46). Next, the data exchange unit 21c transmits a copy request (copy request information) requesting copying of the content to the content management server 6 by the web browser displaying the operation display area 112c (S47). This copy request includes the display position information p2 acquired in step S45, and the content ID 11 and the URL of the personal electronic canvas dc3 that are read out in step S46. The data exchange unit 61 of the content management server 6 receives the copy request requesting copying of the content.

Next, the content management server 6 identifies a content of the copy request (S48). A description is now given of an operation of identifying the content of the request, with reference to FIG. 9.

The determination unit 65 determines whether a content ID is received in step S47 (S48-1). When the determination unit 65 determines that the content ID is received in step S48-1 (YES), the determination unit 65 identifies the copy request as a copy request requesting copying of a content of a screen element (S48-2). By contrast, when the determination unit 65 does not determine that the content ID is not received (or determines that no content ID is received) in step 48-1 (NO), the determination unit 65 identifies the copy request as a copy request requesting copying of a content of the entire screen, which is a screen capture image (S48-3). Note that, in the present embodiment, since the content ID 11 is received in step S47, the determination unit 65 identifies the copy request as a copy request requesting copying of a content of a screen element.

Referring again to FIG. 7, the storing and reading processor 69 reads out the content “C” identified by the content ID from the personal content management table for the personal electronic canvas dc3 in the personal content management DB 6001, based on the URL of the personal electronic canvas dc 3 (S49). The generation unit 63 creates a new content ID 12 (S50). Then, the storing and reading processor 69 stores the display position information p2 received in step S47, the data of the content “C”, which is the screen element, read in step S49, and the content ID 12 generated in step S50 in association with each other in the shared content management DB 6002 (S51). Thus, at the content management server 6, the data of the content “C” is copied from the personal content management DB 6001 to the shared content management DB 6002. This data copy process corresponds to steps S7 and S8 in FIG. 5 illustrating a concept of the operation.

The processes of steps S66 to S71 in FIG. 10 are substantially the same as processes of steps S26 to S31 in FIG. 6, except that the personal content management DB 6001 and the personal content management DB 2001c are replaced with the shared content management DB 6002 and the shared content management DB 2002c. Specifically, the data exchange unit 61 transmits an update notification, which is a notification indicating an update of the shared electronic canvas, to the personal terminal 2c (S66). Note that when multiple personal terminals 2 access the same shared electronic canvas (URL), the content management server 6 transmits the update notification to each of the multiple personal terminals 2. Thereby, the data exchange unit 21c receives the update notification by the web browser displaying the operation display area 112c of the personal terminal 2c.

Next, the data exchange unit 21c transmits a request (request information) for updated content data and display position information to the content management server 6 by the web browser displaying the operation display area 112c of the personal terminal 2c (S67). The data exchange unit 61 of the content management server 6 receives the request for the updated content data and the display position information.

Next, the storing and reading processor 69 of the content management server 6 reads out the content ID 12 corresponding to the updated content, the data of the content “RC”, and the display position information p2 from the shared content management DB 6002 (S68). Then, the data exchange unit 61 transmits the content ID 12, the data of the content “RC”, and the display position information p2 to the personal terminal 2c (S69). Thereby, the data exchange unit 21c receives the content ID 12, the data of the content “RC”, and the display position information p2 by the web browser of the personal terminal 2c.

Next, the storing and reading processor 29c of the personal terminal 2c stores the content ID 12, the content data, and the display position information p2 that are received in step S69 in association with each other in the shared content management DB 2002c (S70). Thereby, the display control unit 24c updates the operation display area 112c to display the content “RC”, which is a screen element, by the web browser of the personal terminal 2c (S71).

As described heretofore, according to the present embodiment, in the same virtual room, since the content “C” as a screen element can be copied from the operation display area 102c displayed by the web browser to the operation display area 112c displayed by the web browser. Thereby, the needs for coordination of a content between multiple operation display areas displayed on a web browser are responded.

Further, the user C of the personal terminal 2c performs an operation of copying the content “C” as a screen element from the operation display area 102c to a desired position in the operation display area 112c by drag and drop at his or her own personal terminal 2c, thereby causing the content management server 6 to copy data of the content “C” as the screen element from the personal content management DB 6001 to the shared content management DB 6002. As described, when the user C performs an operation (drag and drop) at the personal terminal 2c, the personal terminal 2c transmits the content ID of the content to be displayed and the display position information to the content management server 6. Accordingly, there is no need to transmit content data that consumes a relatively large amount of communication data from the personal terminal 2c to the content management server 6. This shortens communication time. Consequently, a time period until the content copied to the operation display area 112c is displayed by the web browser of the personal terminal 2c is further shortened.

Specifically, the time period until the copied content is displayed on the operation display area 112c is almost equals to a time period for downloading the content data to be copied. For example, on the assumption that a communication speed for downloading is equal to a communication speed for uploading, when uploading the content ID of the content and the display position information from the personal terminal 2c to the content management server 6 as in the present embodiment, the time period until the content is displayed in the operation display area 112c is reduced by about half, compared with when the data of the content is copied at the personal terminal 2a and the data of the content is uploaded from the personal terminal 2c to the content management server 6. In addition, in the current network environment, the communication speed for uploading is sometimes slower than the communication speed for downloading. Accordingly, in fact, the time period until the content is displayed is reduced by more than half. In particular, when a target to be dragged and dropped is not the screen element but the entire screen, the content data amount is large. In this case, according to the present embodiment, a time period until the copied content is displayed on the operation display area 112c is further shortened.

### Second Embodiment

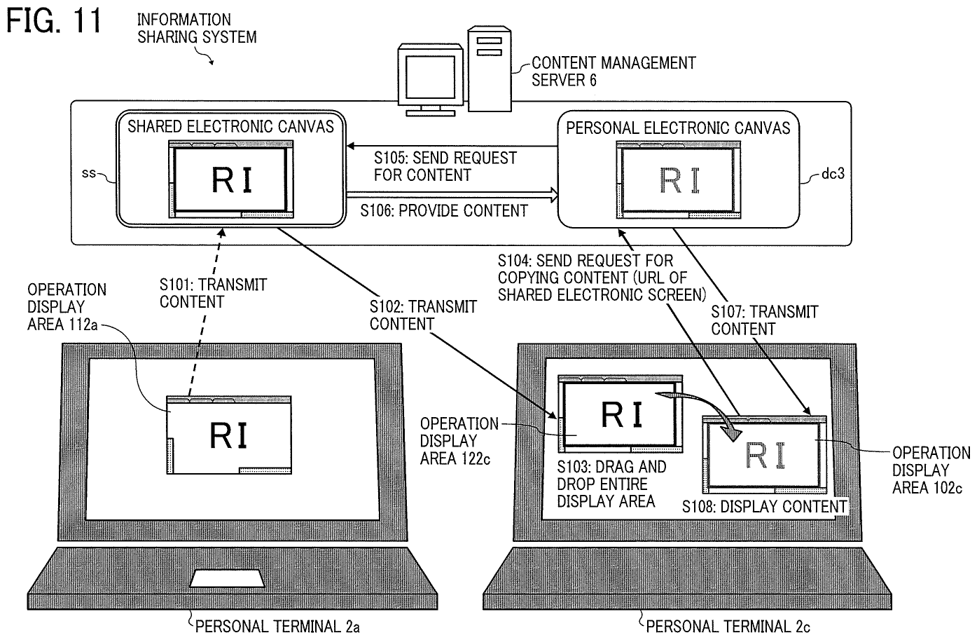

A description is now given of a second embodiment of the present disclosure, with reference to FIG. 11 to FIG. 13. Since the overview, the hardware configuration and the functional configuration of the information sharing system of the second embodiment are substantially the same as those of the first embodiment, the description given hereinafter is of operation or processes according to the second embodiment.

### Overview of Operation or Processes:

First, a description is given of an overview of an operation or processes according to the second embodiment, with reference to FIG. 11. FIG. 11 is a conceptual diagram illustrating processes of copying a content from the shared electronic screen to the personal electronic canvas, according to the second embodiment.

Note that the operation display area 102c represents a given area in the personal electronic canvas dc3 having an infinite space.

With reference to FIG. 9, a description is given of a case where the personal terminal 2a transmits, to the shared electronic screen ss, data of a content of the entire screen on which text data “RI” is input according to the user A's instruction, to cause the screen to be shared with the personal terminal 2b, the personal terminal 2c and the shared terminal 4, and in this state, the user C copies the content of the entire screen that is shared to the personal electronic canvas dc 3 and handles the content of the entire screen as personal data.

Note that in the present embodiment, the content of the entire screen is an example of a particular content. Further, a storage location (storage area) in the storage unit 6000, which is an access destination (URL) to the shared electronic screen ss, is an example of a first storage area in the storage unit 6000. Further, a storage location (storage area) in the storage unit 6000, which is an access destination (URL) to the personal electronic canvas dc3, is an example of a second storage area in the storage unit 6000.

First, at the personal terminal 2a, a content “RI” is displayed on the operation display area 112a, and data of a content of the entire screen is transmitted to the shared electronic screen ss of the content management server 6 (S101). The content management server 6 stores the data of the content of the entire screen in a storage area for the shared electronic screen ss in the storage unit 6000. The data transmitted in step S101 can be either moving image data or still image data.

Next, the user C causes the personal terminal 2c to display the operation display area 122c, and the content management server 6 transmits the data of the content of the entire screen to the personal terminal 2c (S102). At the personal terminal 2c, the content of the entire screen is displayed in the operation display area 122c by the web browser.

Further, at the personal terminal 2c, the operation display area 102c for displaying a content of the personal electronic canvas dc3 is displayed.

In this state, in order to copy the content of the entire screen displayed on the operation display area 122c to the user C's personal electronic canvas dc 3, the user C drags and drops the content (in this embodiment, a screen capture image by the personal terminal 2a), which is the entire screen on the operation display area 122c, to a desired position on the operation display area 102c to copy the content (S103). Note that in the present embodiment, the operation display area 122c is an example of a first operation display area, and the operation display area 102c is an example of a second operation display area.

Next, the personal terminal 2c sends a copy request requesting copying of the content of the entire screen to the content management server 6 by the web browser that displays the operation display area 102c (S104). This copy request includes an URL of the shared electronic screen ss, which is a copy source. That is, the copy source can be specified by the drag and drop operation. Different from the first embodiment, in the present embodiment, the content is not the screen element but the entire screen. In other words, there is only one copy target, which is the content of the entire screen. Accordingly, there is no need to specify the content. For this reason, a content ID of the content of the entire screen is not transmitted.

Next, at the content management server 6, the personal electronic canvas dc3 sends a request for data of the content to the URL of the shared electronic screen ss (S105). Next, at the content management server 6, the shared electronic screen ss provides data of the content of the entire screen to the personal electronic canvas dc3 (S106). In response, the content management server 6 transmits the data of the content of the entire screen to the personal terminal 2c participating in the remote meeting (S107). At the personal terminal 2c, the content of the entire screen is displayed in the operation display area 102c by the web browser (S108).

As described heretofore with reference to FIG. 11, the user C of the personal terminal 2c performs an operation of copying the content of the entire screen from the operation display area 122c to the operation display area 102c by drag and drop at his or her own personal terminal 2c, thereby causing the content management server 6 to copy data of the content of the entire screen from the shared electronic screen ss to the personal electronic canvas dc3.

Similar to the first embodiment, in the present embodiment, data is not copied only within the personal terminal 2c to copy a content of the operation display area 122c to the operation display area 102c. It is the content management server 6 that copies the data, and the personal terminal 2c displays the copied content by the web browser.

In the present embodiment, a content is dragged and dropped from the shared operation display area 122c displayed on the personal terminal 2c to the personal operation display area 102c. However, the present embodiment is not limited to this, and for example, a content can be dragged and dropped from a shared operation display area displayed on the personal terminal 2a or the personal terminal 2b to a personal operation display area displayed on the personal terminal 2a or the personal terminal 2b. In another example, a content can be dragged and dropped from the shared operation display area displayed on the shared terminal 4 to the shared operation display area.

### Details of Operation or Processes:

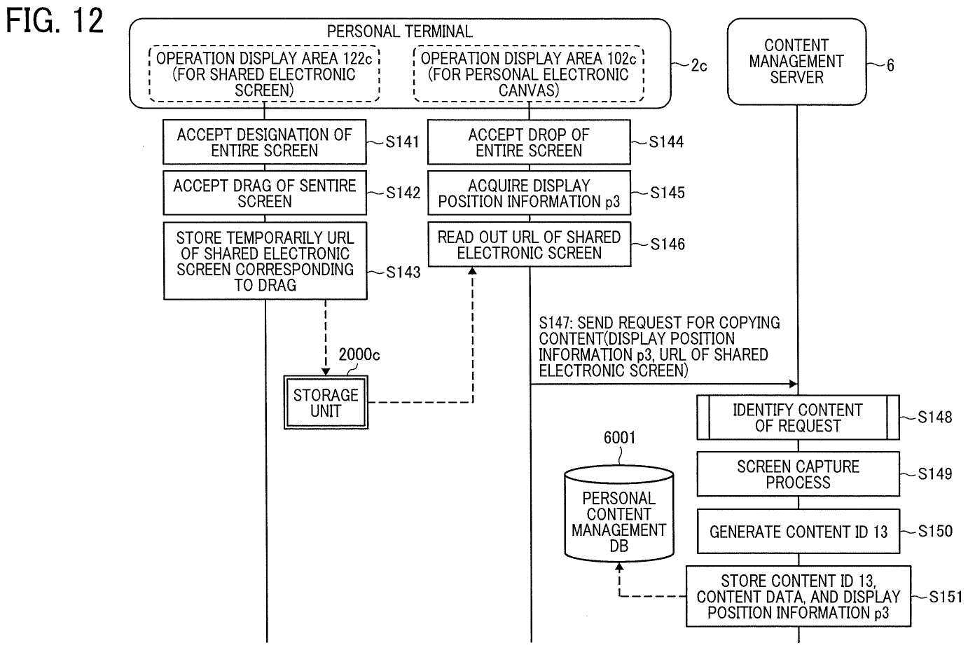

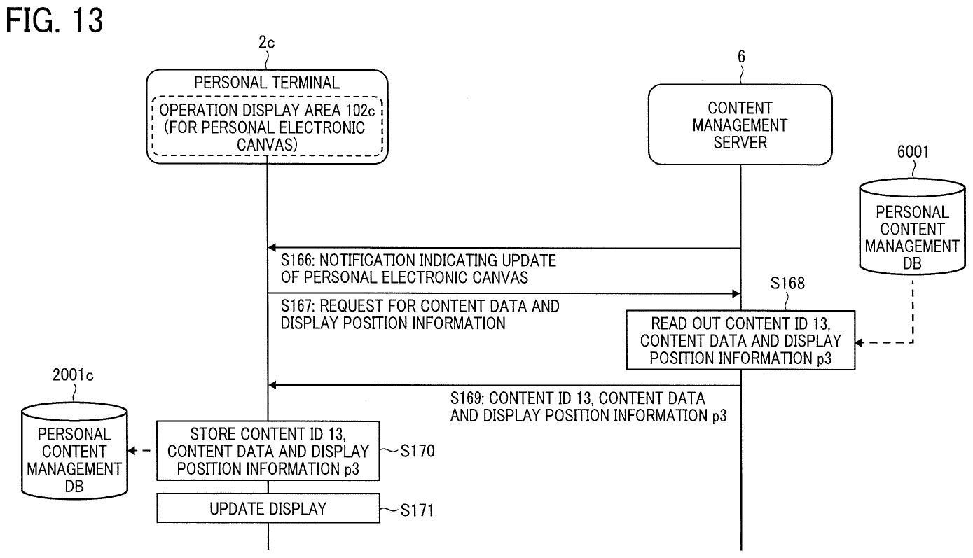

Next, a description is given of details of operation or processes in the second embodiment, with reference to FIG. 12 and FIG. 13. Specifically, a description now is given of processes corresponding to FIG. 7 to FIG. 10. FIG. 12 and FIG. 13 are sequence diagrams each illustrating an operation of copying, in a case where a content to be copied is an entire screen. More specifically, a description is given of details of processes of step S103 and subsequent steps, on the assumption that the processes of step S101 and step S102 has already been performed and that at the personal terminal 2c, the content of the entire screen is displayed in the operation display area 122c by the web browser and the operation display area 102c for displaying a content of the personal electronic canvas dc3 is displayed.

First, when the user C designates the content of the entire screen displayed on the operation display area 122c with the mouse 212 of the personal terminal 2c, the acceptance unit 22c accepts the designation of the content of the entire screen (S141). When the user C drags with the mouse 212, the acceptance unit 22c accepts the drag of the content of the entire screen (S142). Then, the storing and reading processor 29c temporarily stores an URL of the shared electronic screen ss corresponding to the drag in a clipboard of the storage unit 2000c (S143).

Next, when the user C drops the content of the entire screen at a desired display position in the operation display area 102c with the mouse 212, the acceptance unit 22c accepts the drop (S144). The image processor 23c acquires display position information p3 indicating the drop position in the personal electronic canvas dc3 by the web browser of the personal terminal 2c (S145). The storing and reading processor 29c reads out the URL of the shared electronic screen ss stored in the storage unit 2000c (S146). Next, the data exchange unit 21c transmits a copy request (copy request information) requesting copying of the content to the content management server 6 by the web browser that displays the operation display area 102c (S147). This copy request includes the display position information p3 acquired in step S145 and the URL of the shared electronic screen ss that is read out in step S146. The data exchange unit 61 of the content management server 6 receives the copy request requesting copying of the content.

Next, the content management server 6 identifies a content of the copy request (S148). Since this determination is the same or substantially the same manner as step S48 of the first embodiment and is performed in the same or substantially the same manner as described above with reference to FIG. 9, the redundant description thereof is omitted below. Note that, in the present embodiment, no content ID is received in step S147, the determination unit 65 identifies the copy request as a copy request requesting copying of a content of a screen capture image (entire screen).

Next, the storing and reading processor 69 reads out data of the content of the entire screen from the storage unit 6000, based on the URL of the shared electronic screen ss (S149). The generation unit 63 of the content management server 6 generates a new content ID 13 (S150). Then, the storing and reading processor 69 stores the display position information p3 received in step S147, the data of the content, which is the entire screen, read out in step S149, and the content ID 13 generated in step S150 in association with each other in the personal content management DB 6001 (S151). Thus, at the content management server 6, the data of the content is copied from the storage unit 6000 to the personal content management DB 6001. This data copy process corresponds to steps S105 and S106 in FIG. 11 illustrating a concept of the operation.

The processes of steps S166 to S171 in FIG. 13 are substantially the same as processes of steps S66 to S71 in FIG. 10, except that the shared content management DB 6002 and the shared content management DB 2002c are replaced with the personal content management DB 6001 and the personal content management DB 2001c. Specifically, the data exchange unit 61 transmits an update notification, which is a notification indicating an update of the personal electronic canvas, to the personal terminal 2c (S166). In a case where the user C has multiple personal terminals 2 and accesses the same personal electronic canvas (URL) from the multiple personal terminals 2, the content management server 6 sends the update notification to each of the multiple personal terminals 2 of the user C. Thereby, the data exchange unit 21c receives the update notification by the web browser that displays the operation display area 102c of the personal terminal 2c.

Next, the data exchange unit 21c transmits a request (request information) for updated content data and display position information to the content management server 6 by the web browser that displays the operation display area 102c of the personal terminal 2c (S167). The data exchange unit 61 of the content management server 6 receives the request for the updated content data and the display position information.

Next, the storing and reading processor 69 of the content management server 6 reads out the content ID 13 corresponding to the updated content, the data of the entire screen, and the display position information p3 from the personal content management DB 6001 (S168). Then, the data exchange unit 61 transmits the content ID 13, the data of the content of the entire screen, and the display position information p3 to the personal terminal 2c (S169) Thereby, the data exchange unit 21c receives the content ID 13, the data of the content of the entire screen, and the display position information p3 by the web browser of the personal terminal 2c.

Next, the storing and reading processor 29c of the personal terminal 2c stores the content ID 13, the content data, and the display position information p3 that are received in step S169 in association with each other in the personal content management DB 2001c (S170). Thereby, the display control unit 24c updates the operation display area 102c to display the content, which is the entire screen, by the web browser of the personal terminal 2c (S171).

As described heretofore, according to the present embodiment, the user C of the personal terminal 2c performs an operation of copying the content of the entire screen from the operation display area 122c to a desired position in the operation display area 102c by drag and drop at his or her own personal terminal 2c, thereby at the content management server 6, screen capture is performed and data of the content of the entire screen is copied to the personal content management DB 6001. As described, when the user C performs an operation (drag and drop) at the personal terminal 2c, the personal terminal 2c transmits the display position information of a content to be copied to the content management server 6. Accordingly, there is no need to transmit content data of an entire screen that consumes a relatively large amount of communication data from the personal terminal 2c to the content management server 6. This shortens communication time. Consequently, a time period until the content copied to the operation display area 102c is displayed by the web browser of the personal terminal 2c is further shortened.

### Variations:

The above-described embodiments are illustrative and do not limit the present disclosure. For example, elements and/or features of different illustrative embodiments may be combined with each other and/or substituted for each other within the scope of the present disclosure. Thus, numerous additional modifications and variations are possible in light of the above teachings.

For example, the “drag and drop” operation includes an operation by touching with a finger(s), an operation by voice, an operation according to movement of a line of sight, and an operation by brain waves, in addition to an operation with a mouse and/or a keyboard.

For example, although the description of the embodiments given heretofore is of a case where the Canvas element of HTML is used, alternatively, WebGL, SVG (scalable vector graphics), FLASH (registered trademark), etc. can be used.

Also, although in the above embodiments, two operation display areas are displayed by one web browser, alternatively two web browsers (a first web browser and a second web browser) respectively display two operation display areas (a first operation display area and a second operation display area). In another example, instead of two operation display areas, three or more web browsers can display operation display areas respectively (in this case, three or more operation display areas). In still another example, one web browser can display three or more operation display areas.

Although the description given heretofore of the embodiments is of a case where each of the personal electronic canvas and the shared electronic canvas is an infinite electronic canvas, the present disclosure is not limited to this. Alternatively, each of the personal electronic canvas and the shared electronic canvas can be a finite electronic canvas.

In addition, the personal electronic canvas can be a limited finite electronic canvas displayed within the displayable range of the display 208 of the personal terminal 2. Similarly, the shared electronic canvas can be a limited finite electronic canvas displayed within the displayable range of the display 408 of the shared terminal 4. In this case, the problem as described above with reference to FIG. 8, that is, the problem that a content displayed at the display position (p1) in the operation display area 102 is not displayed in the operation display area 112c does not arise. Accordingly, in step S45, the personal terminal 2 does not need to acquire the display position information p2 for the operation display area 112c, and can use the display position information p1 described with reference to FIG. 6.

In addition, although the description given heretofore of the embodiments is of a case where the drag and drop is copying of a content, the present disclosure is not limited to this. Alternatively, the drag and drop can include a cut and paste of a content.

Although in the above embodiments, no description is given of a case where one or more other terminals or one or more other servers relay data (or information) on a communication path between the personal terminal 2 and the shared terminal 4 and the content management server 6, one or more other terminals or one or more other servers can relay data (or information).

Further, in the example of FIG. 1, the shared terminal 4 and the shared electronic canvas cc can be omitted.

Each of the functions (see FIG. 3) of the above-described embodiments can be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

There is a need to display not only a shared window but also a personal window by a web browser and display a content acquired from a server on the personal window as well, thereby linking contents between operation display areas such as a plurality of windows displayed by the web browser.

According to one or more embodiments of the present disclosure, contents can be linked between a first operation display area and a second operation display area, which are displayed by a web browser.

Each of the above embodiments also discloses inventions of aspects as described below.

### Appendix 1:

A content management server manages data of a content to be displayed by a web browser of a communication terminal. The content management server includes:
a memory including a first storage area and a second storage area, the first storage area being configured to store data of a content to be displayed in a first operation display area by the web browser at the communication terminal, the second storage area being configured to store data of a content to be displayed in a second operation display area by the web browser at the communication terminal; and
circuitry to
receive location specifying information that specifies the first storage area, the location specifying information being transmitted by the communication terminal in response to a drag and drop of a particular content displayed in the first operation display area to the second operation display area at the communication terminal,
copy data of the particular content stored in the first storage area specified by the location specifying information to the second storage area and store the copied data, and
transmit the data of the particular content stored in the second storage area so that the communication terminal receives the data.

### Appendix 2:

In the content management server according to Appendix 1, the circuitry is further configured to:
receive particular content identification information for identifying the data of the particular content transmitted by the communication terminal; and
in response to receiving the content identification information, transmit the data of the particular content, which is data of a screen element to be displayed in the second operation display area, so that the communication terminal receives the data of the particular content.

### Appendix 3:

In the content management server according to Appendix 2, the first operation display area is an operation display area for displaying a shared screen, and the second operation display area is an operation display area for displaying a personal content.

### Appendix 4:

In the content management server according to Appendix 1, the particular content is a content of an entire screen displayed in the first operation display area.

### Appendix 5:

In the content management server according to Appendix 1, the first operation display area is an operation display area for displaying a content of a shared screen, and the second operation display area is an operation display area for displaying a personal content.

### Appendix 6:

An information sharing system includes:
the content management server according to any one of Appendices 1 to 5; and
the communication terminal.

### Appendix 7:

In the information sharing system according to Appendix 8, the communication terminal includes circuity to:
display a first operation display area and a particular content in the first operation display area, and display a second operation display area by a web browser;
accept a process of causing the particular content displayed in the first operation display area to be dragged and dropped in the second operation display area;
in response to accepting the process, transmit location specifying information that specifies a location of data of the particular content to the content management server;
receive the data of the particular content to be displayed in the second operation display area, the data of the particular content being transmitted by the content management server in response to transmission of the location specifying information; and
display the particular content in the second operation display area.

### Appendix 8:

A communication method is performed by a content management server that manages data of a content to be displayed by a web browser of a communication terminal. The content management server includes a memory including a first storage area and a second storage area, the first storage area being configured to store data of a content to be displayed in a first operation display area by a web browser at the communication terminal, the second storage area being configured to store data of a content to be displayed in a second operation display area by the web browser at the communication terminal.

The method includes:
receiving location specifying information that specifies the first storage area, the location specifying information being transmitted by the communication terminal in response to a drag and drop of a particular content displayed in the first operation display area to the second operation display area at the communication terminal;
copying data of the particular content stored in the first storage area specified by the location specifying information to the second storage area and store the copied data; and
transmitting the data of the particular content stored in the second storage area so that the communication terminal receives the data.

### Appendix 9:

In the communication method according to Appendix 8, the receiving includes receiving particular content identification information for identifying the data of the particular content transmitted by the communication terminal, and
the transmitting includes, in response to the receiving the content identification information, transmitting the data of the particular content, which is data of a screen element to be displayed in the second operation display area, so that the communication terminal receives the data of the particular content.

### Appendix 10:

A program for causing a computer to perform the method of Appendix 8 or 9.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

What is claimed is:

1. A communication terminal communicable with a content management server, the communication terminal comprising circuitry to:
display a first operation display area, a content in the first operation display area based on data of the content transmitted by the content management server, and a second operation display area by a web browser;
receive a drag and drop operation for causing the content displayed in the first operation display area to be dragged and dropped to the second operation display area;
in response to reception of the drag and drop operation, transmit location specifying information that specifies a location of data of the dragged and dropped content, to the content management server;
receive the data of the dragged and dropped content to be displayed in the second operation display area, the data of the dragged and dropped content being transmitted by the content management server in response to transmission of the location specifying information; and
display the dragged and dropped content in the second operation display area.

2. The communication terminal of claim 1,
wherein the circuitry is further configured to:
transmit content identification information for identifying data of a screen element to be displayed in the second operation display area to the content management server, the screen element being the data of the dragged and dropped content;
receive the data of the screen element, the data of the screen element being transmitted by the content management server in response to transmission of the content identification information.

3. The communication terminal of claim 2,
wherein the first operation display area is an operation display area for displaying a shared screen, which is an electronic screen shared and viewed by a plurality of users, and the second operation display area is an operation display area for displaying a personal content, which is a content edited and viewed by a user individually.

4. The communication terminal of claim 1,
wherein the dragged and dropped content is a content of an entire screen displayed in the first operation display area.

5. The communication terminal of claim 1,
wherein the first operation display area is an operation display area for displaying a content of a shared screen, which is an electronic screen shared and viewed by a plurality of users, and the second operation display area is an operation display area for displaying a personal content, which is a content edited and viewed by a user individually.

6. An information sharing system, comprising:
the communication terminal of claim 1; and
the content management server.

7. The information sharing system of claim 6,
wherein the content management server comprises:
a memory including a first storage area and a second storage area, the first storage area being configured to store data of a content to be displayed in the first operation display area by a web browser at the communication terminal, the second storage area being configured to store data of a content to be displayed in the second operation display area by the web browser at the communication terminal; and
circuitry to
receive location specifying information that specifies the first storage area, the location specifying information being transmitted by the communication terminal in response to a drag and drop of a content displayed in the first operation display area to the second operation display area at the communication terminal,
copy data of the dragged and dropped content stored in the first storage area specified by the location specifying information to the second storage area to store the copied data in the second storage area, and
transmit the data of the dragged and dropped content stored in the second storage area so that the communication terminal receives the data.

8. A display control method performed by a communication terminal communicable with a content management, the method comprising:
displaying a first operation display area, a content in the first operation display area based on data of the content transmitted by the content management server, and a second operation display area by a web browser;
receiving a drag and drop operation for causing the content displayed in the first operation display area to be dragged and dropped to the second operation display area;
in response to receiving the drag and drop operation, transmitting location specifying information that specifies a location of data of the dragged and dropped content, to the content management server;
receiving the data of the dragged and dropped content to be displayed in the second operation display area, the data of the dragged and dropped content being transmitted by the content management server in response to transmission of the location specifying information; and
displaying the dragged and dropped content in the second operation display area.

9. The display control method of claim 8,
wherein the transmitting includes transmitting content identification information for identifying the data of the dragged and dropped content to the content management server, and
wherein the receiving includes receiving the data of the dragged and dropped data, which is data of a screen element to be displayed in the second operation display area, the data of the screen element being transmitted by the content management server in response to the transmitting of the content identification information.

10. A computer-readable non-transitory storage medium storing a program for causing a computer to execute the method of claim 9.
